(19) United States
(12) Patent Application Publication
(10) Pub. No.: US 2013/0000138 A1
(43) Pub. Date: Jan. 3, 2013

(54) OVEN AND DRYING SYSTEM USING THE SAME

(75) Inventors: SHENG-FA LIN, Shenzhen City (CN); FENG YAO, Shenzhen City (CN); YONG-HUA ZHANG, Shenzhen City (CN); WEI SHEN, Shenzhen City (CN); JIN-LONG YU, Shenzhen City (CN); HUA-WEI CHEN, Shenzhen City (CN)

(73) Assignee: HON HAI PRECISION INDUSTRY CO., LTD., Tu-Cheng (TW)

(21) Appl. No.: 13/398,476

(22) Filed: Feb. 16, 2012

(30) Foreign Application Priority Data
Jul. 1, 2011 (CN) 201110183646.4

(51) Int. Cl. F26B 25/06; F26B 23/04; F26B 19/00

(52) U.S. Cl. 34/88; 34/218

(57) ABSTRACT

A drying system positioned after a foregoing workstation or system for drying workpieces, includes a transport belt for the workpieces to be positioned on; and at least one oven including a main body and a drying member positioned on top of the main body for heating the air in the oven. The main body of the oven includes a base and an air guiding member positioned on the base, and the base and the air guiding member cooperatively define a chamber running through the at least one oven. The transport belt passes through the foregoing workstation and through the chamber. The integration of the drying system with other manufacturing workstations or systems may save time and labor used for transporting workpieces in between drying and other manufacturing steps. The disclosure also provides an oven utilized in the drying system.

### BACKGROUND

1. Technical Field

The present disclosure relates generally to oven and a drying system using the oven, especially to an oven used for drying paint and a drying system using the same.

2. Description of Related Art

In many production lines, workpieces must be transferred from a coating, painting, or dyeing area and positioned on trays, or the like, to then be transported through an oven to be dried. The lack of integration of the coating and drying process is evident from the need for transferring the workpieces from one place to another for drying after coating, which adds to the time and cost for manufacturing of the workpieces and the corresponding product.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of one embodiment of a drying system including a plurality of ovens.

FIG. 2 is an isometric view of the oven including an air guiding member of FIG. 1.

FIG. 3 is a side view of the oven of FIG. 2.

FIG. 4 is an exploded, isometric view of the oven of FIG. 2.

FIG. 5 is an isometric view of the air guiding member of FIG. 2.

### DETAILED DESCRIPTION

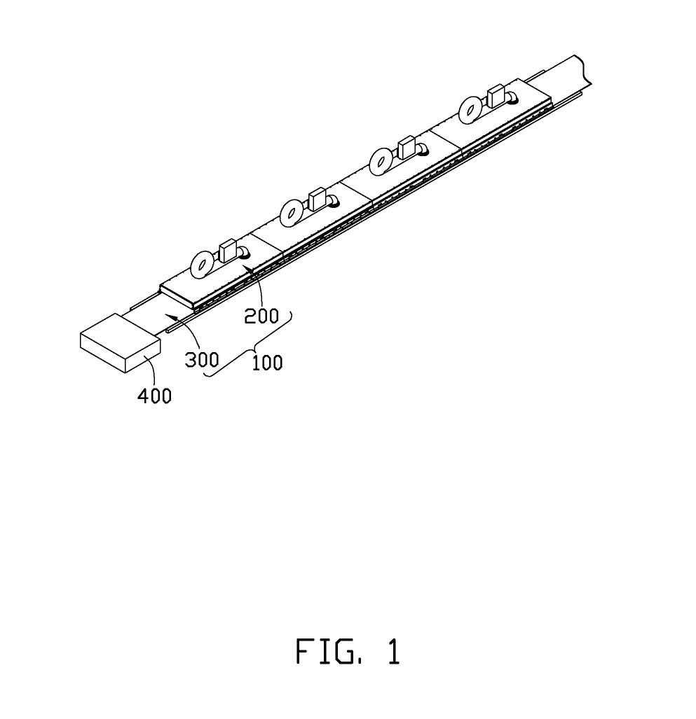

Referring to FIG. 1, one embodiment of a drying system 100 is utilized to dry workpieces (not shown) after a task completion at a foregoing system or manufacturing workstation such as a paint system 400. The drying system 100 includes a plurality of ovens 200 and a transport belt 300 passing through the ovens 200. The transport belt 300 passes through the paint system 400 and through the ovens 200.

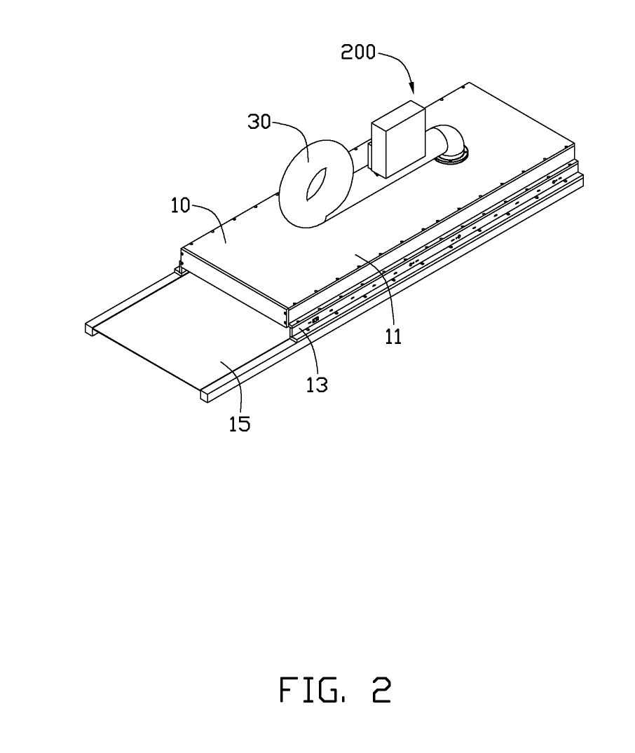

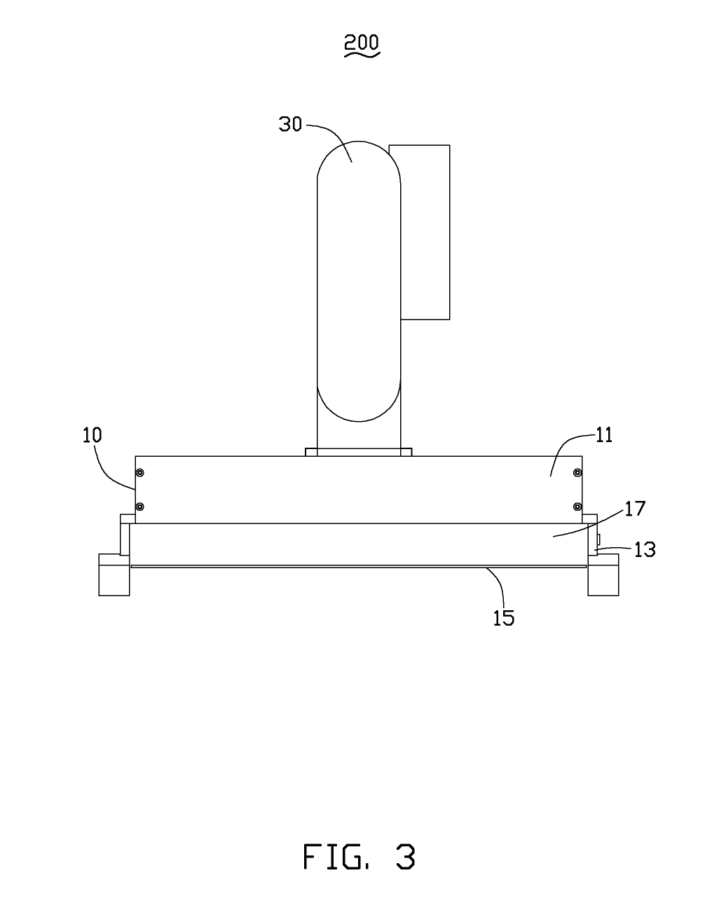

Referring to FIGS. 2 and 3, each oven 200 includes a main body 10 and a drying member 30 positioned on top of the main body 10. The transport belt 300 passes through the main body 10 for transporting workpieces to be dried in the ovens 200. The drying member 30 may heat and transport air to dry the workpieces.

The main body 10 includes an air guiding member 11, two guide rails 13, and a base 15. The two guide rails 13 are positioned on opposite sides of the base 15, and the air guiding member 11 is fixed on the two guide rails 13. The air guiding member 11, the two guide rails 13, and the base 15 cooperatively define a chamber 17.

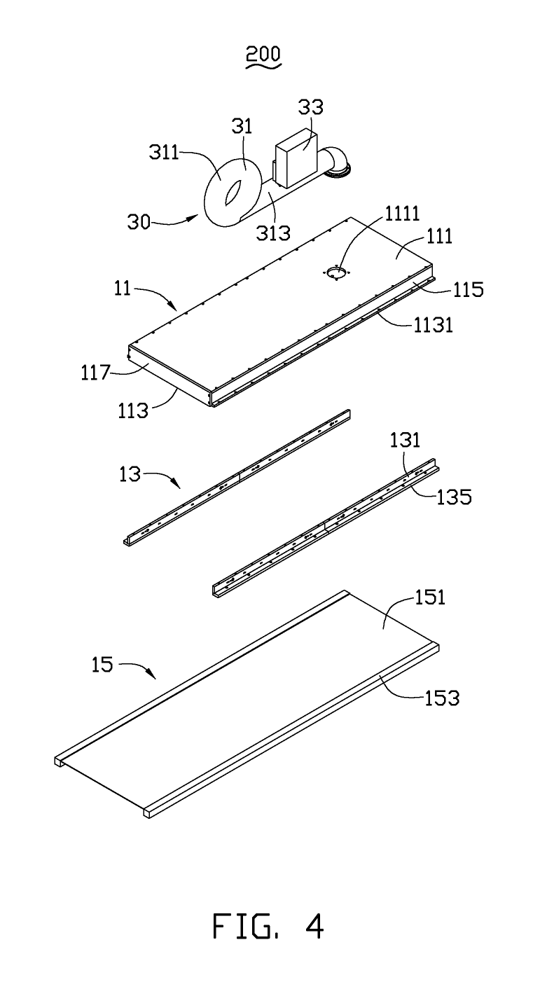

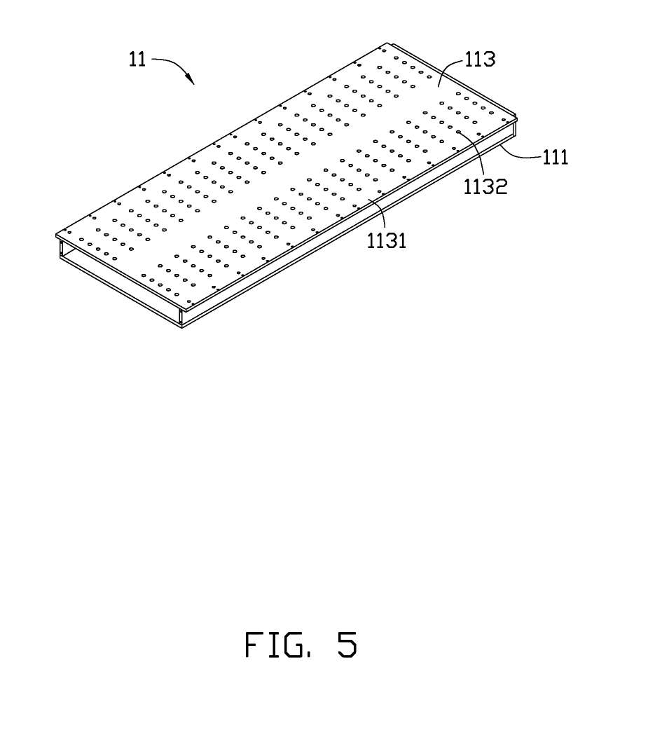

Referring to FIGS. 4 and 5, the air guiding member 11 is a substantially rectangular box. The air guiding member 11 includes a mounting plate 111, an air guiding plate 113 facing to the mounting plate 111, and two first side plates 115 and two second side plates 117 connecting the mounting plate 111 to the air guiding plate 113, respectively. The mounting plate 111 defines a mounting hole 1111 for mounting the drying member 30. Opposite side edges of the air guiding plate 113 protrude out of the two first side plates 115 to form a connecting portion 1131. The air guiding member 11 is fixed to the two guide rails 13 via the connecting portion 1131. The air guiding plate 113 also defines a plurality of holes 1132 to direct hot air onto workpieces that are passing by.

The guide rail 13 is substantially L-shaped in cross-section, and the length of the guide rail 13 is equal to that of the first side plate 115. The guide rail 13 includes a main portion 131 and a fixing portion 135 extending from one side of the main portion 131 together to form the L-shape. The connecting portion 1131 of the air guiding plate 113 is fixed on the main portion 131, and the fixing portion 135 is fixed on the base 15. The air guiding member 11 is thereby fixed to the base 15 via the guide rails 13.

In the illustrated embodiment, the main portion 131 of the guide rail 13 can be made of heat-resistant transparent materials, such as acrylic and polymethylpentene, so that operators can observe the interior of the chamber 17 from outside. It should be appreciated that none, some, or all of the two main portions 131 may be made of the transparent material depending on viewing or monitoring needs.

The base 15 includes a bottom plate 151 and two support portions 153 fixed to opposite sides of the bottom plate 151. The fixing portion 135 of the guide rail 13 is fixed to the support portion 153. The base 15 is positioned on a work table (not shown). The transport belt 300 passes through the chamber 17, and is slidably positioned on the bottom plate 151.

The drying member 30 includes an air heater 31 and a temperature controller 33 for controlling the air heater 31. The air heater 31 includes an annular circulating tube 311 and a vent pipe 313 extending from and connecting to the circulating tube 311. The temperature controller 33 is fixed on the vent pipe 313. One end of the vent pipe 313 away from the circulating tube 311 is engaged with the mounting hole 1111 of the mounting plate 111 and is fixed to the mounting plate 111, so that hot air heated by the drying member 30 can thereby be transported to the air guiding member 11.

In the illustrated embodiment, the temperature controller 33 includes a plurality of temperature sensors (not shown). The temperature sensors are positioned in the chamber 17 for inspecting the drying temperature of the chamber 17. When the temperature in the chamber 17 is higher than the preset drying temperature, the temperature controller 33 controls the air heater 31 to shut off. When the temperature of the chamber 17 is lower than the preset drying temperature, the temperature controller 33 controls the air heater 31 to switch on or turn on. Thereby, the oven 200 may maintain a constant inside temperature.

When the drying system 100 is working, the workpieces are placed on the transport belt 300 and moved into the chamber 17, with the transport belt 300 continuously connecting the drying system 100 to the paint system 400. The temperature controller 33 controls the air heater 31 to heat the air, and a hot airflow created by the drying member 30 is blown into the air guiding member 11. Then the hot air is guided to the chamber 17 via the holes 1132, and the workpieces would be dried.

In the drying system 100, the transport belt 300 can be configured to run through other systems for manufacturing of the workpieces. For example, the transport belt 300 may be configured directly at the exit of the paint system 400 so that freshly-painted workpieces pass from the paint system 400 directly into the drying system 100 without requiring additional handling. After the transport belt 300 passes through the drying system 100, it can then proceed to a clear coat station, and then on through another drying system 100. As a result, integration of the drying system 100 and other systems of a production line may be integrated, thereby saving time and labor.

It should be appreciated that the guide rails 13 may be omitted, the support portions 153 of the base 15 may extend from the bottom plate 151 to the air guiding member 11. The air guiding member 11 may be fixed on the support portions 153, and the air guiding member 11 and the base 15 cooperatively define the chamber 17.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A drying system for drying workpieces in product manufacturing, comprising:
a transport belt for the workpieces to be positioned on; and
at least one oven, the oven comprising a main body and a drying member positioned on top of the main body for heating the air in the oven;
wherein the drying system is configured and positioned after a foregoing workstation, the main body comprises a base and an air guiding member positioned on the base, the base and the air guiding member cooperatively define a chamber running through the at least one oven, and the transport belt passes through the foregoing workstation and through the chamber.

2. The drying system of claim 1, wherein the main body further comprises two guide rails connecting the air guiding member to the base, and the air guiding member, the two guide rails and the base cooperatively define the chamber.

3. The drying system of claim 2, wherein at least one of the guide rails is made of heat-resistant transparent materials.

4. The drying system of claim 3, wherein at least one of the guide rails is made of acrylic.

5. The drying system of claim 1, wherein the air guiding member comprises a mounting plate and an air guiding plate facing to the mounting plate, the mounting plate defines a mounting hole for mounting the drying member; the air guiding plate and the base cooperatively further define the chamber, and the air guiding plate defines a plurality of holes to direct hot air onto the workpieces.

6. The drying system of claim 5, wherein the drying member comprises an air heater and a temperature controller controlling the air heater, the air heater comprises an annular circulating tube and a vent pipe extending from and connecting to the circulating tube; the temperature controller is fixed on the vent pipe, and one end of the vent pipe away from the circulating tube is engaged with the mounting hole and is fixed to the mounting plate.

7. The oven of claim 6, wherein the temperature controller further comprises a plurality of temperature sensors positioned in the chamber for inspecting a drying temperature of the chamber.

8. An oven for drying workpieces, comprising:
a main body; and
a drying member positioned on top of the main body for heating air;
wherein the main body comprises a base and an air guiding member positioned on the base, and the base and the air guiding member cooperatively define a chamber running through the oven.

9. The oven of claim 8, wherein the main body further comprises two guide rails connected the air guiding member to the base; and the air guiding member, the two guide rails and the base further cooperatively define the chamber.

10. The oven of claim 9, wherein at least one of the guide rails is made of heat-resistant transparent materials.

11. The oven of claim 10, wherein at least one of the guide rails is made of acrylic.

12. The oven of claim 8, wherein the air guiding member comprises a mounting plate and an air guiding plate facing to the mounting plate, the mounting plate defines a mounting hole for mounting the drying member; the air guiding plate and the base further cooperatively define the chamber, and the air guiding plate defines a plurality of holes to direct hot air onto the workpieces.

13. The oven of claim 12, wherein the drying member comprises an air heater and a temperature controller for controlling the air heater, the air heater comprises an annular circulating tube and a vent pipe extending from and connecting to the circulating tube; the temperature controller is fixed on the vent pipe, and one end of the vent pipe away from the circulating tube is engaged with the mounting hole and is fixed to the mounting plate.

14. The oven of claim 13, wherein the temperature controller further comprises a plurality of temperature sensors positioned in the chamber for inspecting a drying temperature of the chamber.
